(19) United States
(12) Patent Application Publication
(10) Pub. No.: US 2024/0338269 A1
(43) Pub. Date: Oct. 10, 2024

(54) RELIABILITY CALCULATION METHOD, RELIABILITY CALCULATION APPARATUS, AND PROGRAM

(71) Applicant: NIPPON TELEGRAPH AND TELEPHONE CORPORATION, Tokyo (JP)

(72) Inventors: Kengo NAKAMURA, Tokyo (JP); Takeru INOUE, Tokyo (JP); Masaaki NISHINO, Tokyo (JP); Norihito YASUDA, Tokyo (JP)

(21) Appl. No.: 18/576,847

(22) PCT Filed: Aug. 10, 2021
(86) PCT No.: PCT/JP2021/029526

§ 371 Date: Jan. 5, 2024

(51) Int. Cl. G06F 11/00

(52) U.S. Cl. CPC G06F 11/008

(57) ABSTRACT

A reliability calculation method according to one embodiment, executed by a computer, includes an input procedure designed to input a connected undirected graph G=(V, E), an operation probability pᵢ of a link eᵢ∈E that constitutes the undirected graph G, and a predetermined set T⊏V of k-1 source nodes; a search procedure designed to generate a directed acyclic graph for calculating a reliability R_{G,p} (T␣{v}) representing the probability that each target node v∈V\T is connected to each of the k-1 source nodes, based on the undirected graph G, the operation probability of operation pᵢ, and the set T; and a probability calculation procedure designed to calculate the reliability R_{G,p} (T␣{v}) for each target node v based on the directed acyclic graph and a correspondence between each vertex of the directed acyclic graph and its adjacent vertex.

### TECHNICAL FIELD

The present invention relates to a reliability calculation method, a reliability calculation apparatus, and a program.

### BACKGROUND ART

For example, in communication networks and power grids, a failure of a link occurs sometimes and the link cannot be used. When such link failures are regarded as probabilistic events, it is possible to calculate the probability that a given number of nodes are connected (i.e., the probability that there is a path connecting any two of a specified number of nodes). The problem of finding the probability that k specified nodes are connected is called the k-terminal network reliability (k-NR) problem, and the probability is also called a reliability. It is known that k-NR belongs to a computationally difficult problem called #P-complete, and numerous studies have now made it possible to obtain accurate probabilities for networks with about 200 links.

In recent years, network infrastructures have generally taken the form of what is called the client-server model. For example, cloud services on the Internet are provided from a web server to browsers (clients) in the network, and in an electric power grid, from substations (servers) to customers (clients). In this case, for each client, a reliability calculation must also be performed for each client to evaluate the probability that the client can connect to the server. For example, if there were k-1 server nodes, this would be a problem of finding k-NR for connecting k-1 servers to one client for all clients, which would require solving k-NR repeatedly. Since this problem can be viewed as an extension of k-NR to fixed server nodes and multiple client nodes, it is referred to the k-terminal reliability problem for fixed sources and multiple targets (hereinafter “k-NR+”). Note that since the target of k-NR+ is not limited to the client-server model, the term “source” is used instead of server and “target” instead of client.

k-NR has been studied for a long time. For example, in NPLs 1 and 2, a method for obtaining a reliability at high speed using a binary decision graph (BDD: Binary Decision Diagram), which can represent combinatorial sets in a compact manner, was proposed. The method described in NPL 3 is a method for solving problems similar to k-NR+ in an approximate manner.

### CITATION LIST

### Non Patent Literature

Non Patent Literature 1: Gary Hardy, Corinne Lucet, and Nikolaos Limnios. K-terminal network reliability measures with binary decision diagrams. IEEE Transactions on Reliability, Vol. 56, pp. 506-515, 2007.
Non Patent Literature 2: Johannes U. Herrmann. Improving reliability calculation with augmented binary decision diagrams. In Proceedings of the 24th IEEE International Conference on Advanced Information Networking and Applications (AlNA 2010), pp. 328-333, 2010.
Non Patent Literature 3: Arijit Khan, Francesco Bonchi, Aristides Gionis, and Francesco Gullo. Fast reliability search in uncertain graphs. In Proceedings of the 17th International Conference on Extending Database Technology (EDBT 2014), pp. 535-546, 2014.

### SUMMARY OF INVENTION

### Technical Problem

However, a method for directly solving k-NR+ has not been proposed so far, and a method for solving k-NR+ at high speed is required.

One embodiment of the present invention was made to address such a program and an object thereof is to solve the k-terminal reliability problem for a fixed source and multiple targets at high speed.

### Solution to Problem

To achieve the object stated above, a reliability calculation method according to one embodiment, is executed by a computer, the method including: an input procedure designed to input a connected undirected graph G=(V, E), an operation probability pᵢ of a link eᵢ∈E that constitutes the undirected graph G, and a predetermined set T⊏V of k-1 source nodes; a search procedure designed to generate a directed acyclic graph for calculating a reliability R_{G,p} (T␣{v}) representing the probability that each target node v∈V\T is connected to each of the k-1 source nodes, based on the undirected graph G, the operation probability of operation pᵢ, and the set T; and a probability calculation procedure designed to calculate the reliability R_{G,p} (T␣{v}) for each target node v based on the directed acyclic graph and a correspondence between each vertex of the directed acyclic graph and its adjacent vertex.

### Advantageous Effects of Invention

It is possible to solve the k-terminal reliability problem for the fixed source and the plurality of targets at a high speed.

### BRIEF DESCRIPTION OF DRAWINGS

FIG. 1 is a diagram illustrating an example of a hardware configuration of a reliability calculation device according to the present embodiment.

FIG. 2 is a diagram illustrating an exemplary functional configuration of a reliability calculation device according to the present embodiment.

FIG. 3 is a diagram (1) illustrating one example of a search diagram.

FIG. 4 is a diagram (2) illustrating one example of a search diagram.

FIG. 5 is a diagram illustrating one example of a processing algorithm executed by a search unit according to the present embodiment.

FIG. 6 is a diagram illustrating one example of a processing algorithm executed by a probability calculation unit according to the present embodiment.

### DESCRIPTION OF EMBODIMENTS

Hereinafter, embodiments of the present invention will be described.

<k-NR and k-NR+>

The mathematical formulation of k-NR and k-NR+ is as follows.

A network is modeled as a connected undirected graph G=(V, E). Let n=|V| be the number of nodes and m=|E| be the number of links. Each link eᵢ∈E has a defined operation probability pᵢ∈[0, 1]. This means that the link eᵢ operates correctly with a probability pᵢ and fails with a probability 1-pᵢ. The state of each link (i.e. whether it is working or has failed) is assumed to be statistically independent of the states of other links. For a subset of links E′ CE, the collection of all states of links in E′ is called “E's state” Given the state X of all links (i.e. links in E), it is considered that E^{X}⊆E is the set of links that are operating, and the subgraph G^{X}=(V, E^{x}) of G consist only of links that are operating. The probability p (X) of this state X can be calculated by the following Equation (1):

[Eq. 1]

$$p ( X ) = {\prod }_{i : {e}_{i} ∈ {E}^{X}} {p}_{i} \cdot {\prod }_{i : {e}_{i} ∈ E ∖ {E}^{X}} ( 1 - {p}_{i} ) \qquad ( 1 )$$

Given a set of nodes K⊆V, the probability R_{G,p} (K) that all nodes in K are connected can be calculated by the following Equation (2):

[Eq. 2]

$${R}_{G , p} ( K ) = {\sum }_{X ∈ {Γ}_{K}} p ( X ) \qquad ( 2 )$$

where IK is the set of all E states X where all nodes in K are connected in GX.

It is k-NR to find R_{G,p} (K) for a node set K (where k is an integer greater than or equal to 2) where k=|K|. That is, the probability R_{G,p} (K) represents the probability that there is a path connecting any two nodes in K; this probability is the reliability.

Using these, k-NR+ can be described as follows. A connected undirected graph G=(V, E), an operation probability pᵢ for each link eᵢ∈E, and a set T⊆V of k-1 source nodes are given. In this case, k-NR+ is to find R_{G,p} (T␣{v}) for each target node v∈V\T.

### <Conventional Method>

Since the reliability value to be obtained in k-NR is expressed in the above Equation (2), it can be calculated if all the E states X can be enumerated such that all the nodes in Tₖ, or K, are connected in G^{X}. However, since the number of E states becomes exponentially large in relation to the number of links, a straightforward enumeration would require an enormous amount of calculation time even for a network of several dozen links. Therefore, the calculation time can be reduced by constructing a BDD with all the link combinations E^{x} such that all the nodes in K are connected, and then using the BDD for probability calculation. In particular, since the methods disclosed in NPLs 1 and 2 allow the above BDD to be constructed directly without enumerating all the states of E such that all the nodes in K are connected, a significant reduction in calculation time can be achieved compared to straightforward enumeration. The method described in NPL 1 is a proposal of the original idea, and the method described in NPL 2 is an improved and faster version of a part of the method described in NPL 1.

Although a method that directly solves k-NR+ has not been proposed so far, NPL 3 describes a method that approximately solves a problem similar to k-NR+. This method allows approximate enumeration of target nodes such that the probability of connecting to one of the source nodes is greater than or equal to some given value.

When considering solving k-NR+, the methods described in NPLs 1 and 2 require the computation of reliability values for each of many target nodes. Specifically, in these methods, for each target node v∈V\T, it is necessary to construct a BDD with all states such that all nodes in T␣{v} are connected, and k-NR is solved for the number of target nodes. Since k-NR for a single target node is also a computationally difficult problem, solving it for the number of target nodes is generally very time consuming.

On the other hand, the method described in NPL 3 cannot be used to quantitatively evaluate the reliability of each target node, because the probability indicating reliability itself cannot be obtained for each target and is an approximate method.

### <Proposed Method>

In the present embodiment, inventors have proposed a method that can solve k-NR+ at high speed and describe a reliability calculation device 10 that implements the proposed method.

The proposed method is based on the method described in NPL 1 and realizes reliability calculation for all target nodes with only one data structure. The BDD used in NPLs 1 and 2 is data that represents a combinatorial set as a loopless graph (called a directed acyclic graph) consisting of a collection of vertices and oriented edges. To distinguish them from the “nodes” and “links” of the original network, the nodes and links of a directed acyclic graph are called “vertices” and “edges,” respectively.

In the methods described in NPLs 1 and 2, the probability that all nodes in K are connected (i.e., the probability that K is connected) is obtained by dynamic programming, which constructs a BDD with a top-down approach from the topmost vertex, called the root, by state search, and computes values for each vertex in turn, following the BDD top-down. The proposed method constructs a directed acyclic graph by searching for states similar to this, but it performs both top-down and bottom-up dynamic programming on the constructed directed acyclic graph. This allows us to solve the more difficult k-NR+ with a calculation load equivalent to that for existing methods solving k-NR. Furthermore, when k is small, that is, when the number of source nodes is small, the proposed method can solve the more difficult k-NR+ with less calculation load than that required by existing methods to solve k-NR.

This proposed method is summarized as follows.

The data structure is slightly modified from the existing method, and not only the top-down dynamic programming method but also the bottom-up dynamic programming method is used. Accordingly, k-NR+, which requires the calculation of reliability for all target nodes, can be solved with a calculation load equivalent to that of the existing method for solving k-NR.

In terms of solving k-NR, when k is small, it can be solved faster than existing methods.

### <Hardware Configuration of Reliability Calculation Device 10>

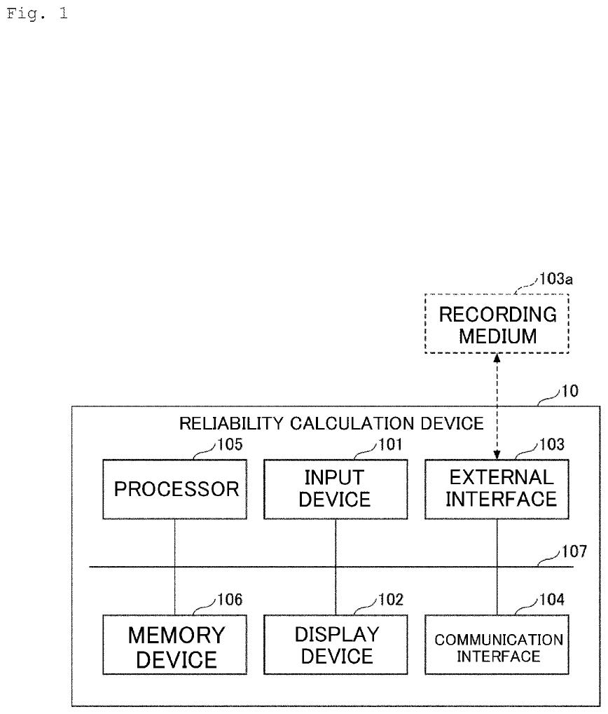

FIG. 1 illustrates a hardware configuration of the reliability calculation device 10 according to the embodiment. As illustrated in FIG. 1, the reliability calculation device 10 according to the embodiment is implemented with a hardware configuration of a general computer or a computer system and includes an input device 101, a display device 102, an external interface 103, a communication interface 104, a processor 105, and a memory device 106. Each of these pieces of hardware is communicatively connected via a bus 107.

The input device 101 is, for example, a keyboard, a mouse, a touchscreen, various physical buttons, or the like. The display device 102 is, for example, a display or display panel. The reliability calculation device 10 may not include at least one of, for example, the input device 101 and the display device 102.

The external interface 103 is an interface with an external device such as a recording medium 103a. The reliability calculation device 10 can perform reading and writing of the recording medium 103a via the external interface 103. Examples of the recording medium 103a include a compact disc (CD), a digital versatile disk (DVD), a secure digital (SD) memory card, and a universal serial bus (USB) memory card.

The communication interface 104 is an interface for connecting the reliability calculation device 10 to a communication network. The processor 105 is one of various arithmetic devices such as, for example, a central processing unit (CPU) and a graphics processing unit (GPU). The memory device 106 is, for example, any of various storage devices such as a hard disk drive (HDD), a solid-state drive (SSD), a flash memory, a random access memory (RAM), and a read only memory (ROM).

The reliability calculation device 10 according to the embodiment has the hardware configuration illustrated in FIG. 1, and thus is capable of implementing various types of processing to be described below. The hardware configuration illustrated in FIG. 1 is exemplary, and the reliability calculation device 10 may include, for example, a plurality of processors 105, a plurality of memory devices 106, or various types of hardware other than those in illustrated.

### <Functional Configuration of Reliability Calculation Device 10>

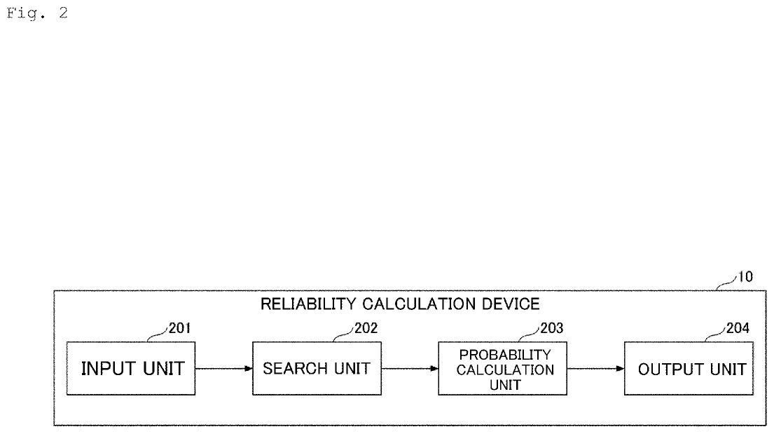

FIG. 2 illustrates a functional configuration of the reliability calculation device 10 according to the embodiment. As shown in FIG. 2, the reliability calculation device 10 according to the present embodiment includes an input unit 201, a search unit 202, a probability calculation unit 203, and an output unit 204. These units are realized, for example, by processing that one or more programs installed in the reliability calculation device 10 causes the processor 105 to execute. It is assumed that the reliability calculation device 10 is given a connected undirected graph G=(V, E), an operation probability pᵢ∈[0.1] for each link eᵢ∈E, and a set T⊆V of source nodes. Furthermore, let n=|V| be the number of nodes and m=|E| be the number of links.

The input unit 201 inputs the given connected undirected graph G, an operation probability pᵢ for each link eᵢ∈E, and a set T⊆V of the source nodes.

The search unit 202 generates (constructs) a directed acyclic graph, called a search diagram, based on the connected undirected graph G, the operation probability pᵢ, and the source node set T input by the input unit 201.

The probability calculation unit 203 calculates the probability R_{G,p} (T␣{v}) of connecting to all source nodes for each target node v∈V\T by dynamic programming based on the search diagram generated by the search unit 202.

The output unit 204 outputs each probability R_{G,p} (T␣{v}) calculated by the probability calculation unit 203. The output unit 204 can output the probability R_{G,p} (T␣{v}) to any predetermined output destination. Such output destinations include, for example, a display device 102 such as a display, a memory device 106, and other devices or equipment connected via a communication network.

The details of the processes executed by the search unit 202 and the probability calculation unit 203 will be mainly explained hereinbelow. Note that the process performed by the search unit 202 is based on the method described in NPL 1, so it is also desirable to refer to NPL 1 as necessary.

In the following description, it is assumed that there are no self-loops (i.e. links connecting the same node) and 1-degree nodes (i.e. nodes with one link connecting to themselves) in the connected undirected graph G given to the reliability calculation device 10. However, this assumption can be easily removed. If there is a self-loop in graph G, such a self-loop can be removed because it does not affect the value of the probability. If there is a 1-degree node in the graph G, reliability can be calculated on the graph with the 1-degree node removed. In particular, w denotes a 1-degree node in the graph G and u denotes the other endpoint of the only link connecting to node w. Using the reliability values of graph G-w with the node w removed from the graph G, the reliability of the original graph G can be calculated by the following Equation (3):

[Eq. 3]

$${R}_{G , p} ( K ) = \{ \begin{matrix}{p}_{i} \cdot {R}_{G - w , p} ( K ⋃ \{ u \} ∖ \{ w \} ) & ( w ∈ K ) \\ {R}_{G - w , p} ( K ) & ( w ∉ K )\end{matrix} \qquad ( 3 )$$

However, for any node v in the graph G′, R_{G,p} ({v})=1. By repeatedly deleting 1-degree nodes, it is possible to obtain a graph consisting only of nodes of degree 2 or higher, or a graph with only one node. Therefore, the reliability in the original graph can be restored by determining the reliability of each target node for the obtained graph.

### <Details of Process Executed by Search Unit 202>

The search unit 202 first determines the order eᵢ, . . . , eₘ of the links, and then performs a search such that the state of the links, i.e. whether they are working or have failed, is determined in order from the earlier link. In other words, when the state of the link set E_{<i}={e₁, . . . , eᵢ₋₁} up to the i−1st is determined, the search unit 202 generates two states of the link set E_{<i+1} up to the i−th by determining which state eᵢ has, and so on. The order of the links is determined, for example, by the method described in Reference 1. However, as it is, this would result in an exponentially large number of searches for the number m of links, so the concept of partition is introduced to summarize equivalent states. First, let the i−th boundary node set Fᵢ be the set of nodes in both the link set E_{<i} up to the i−1st and the link set E_{≥i}={eᵢ, . . . , eₘ) after the i-th. For a state Xxi with E_{<i}, its partition is defined as follows.
If there is a node in T that exists in E_{<i} but is not connected to a node in Fᵢ by an operating link out of E_{<i}, then the partition is ⊥(this is called a branch-and-cut partition).
Otherwise, the partition is defined as a pair of blocks separating the nodes in Fᵢ and a mark (symbol) assigned to each block. Here, two nodes x, y∈Fᵢ are in the same block only if they are interconnected by a link that is operating out of E_{<i}. A mark is also given to a block if at least one or more of the nodes in T are connected to a node in a block by a link that is operating.

By identifying multiple E_{<i} states whose partitions are the same, the search can be greatly accelerated. Thus, instead of considering the link states themselves, a search diagram can be generated by searching for the partitions corresponding to the link states.

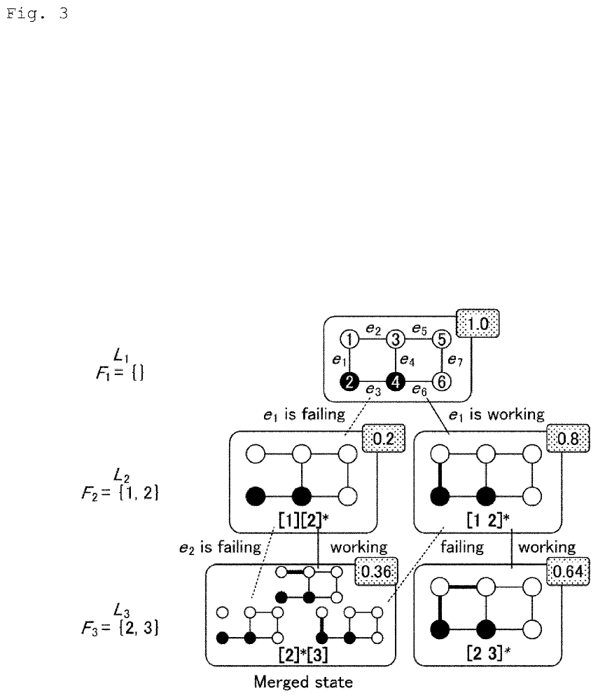

For example, FIG. 3 shows an example of a search with T={2, 4} for the graph in the top rounded square (the graph consisting of nodes 1 to 6 and links eᵢ to e₇). Lᵢ represents the i−th layer of the search diagram. The partitions are represented by bold text, and each block is represented by a node number in square brackets [ ], and the markings are represented by an asterisk * in the upper right corner of the block. The line connecting the graph of Lᵢ of the i−th layer to the graph of i+1th layer is represented as a solid line if the link eᵢ is working, and as a dashed line if the link eᵢ has failed. Furthermore, the number in the upper right corner of the rounded square in Lᵢ of the i−th layer represents the probability that it will be the corresponding division (p (P) shown in Equation (5) below). For example, the number “0.2” in the upper right corner of the left rounded square in the second layer La represents the probability that the partition will be [1] [2] *, and the number “0.8” in the upper right corner of the right rounded square represents the probability that the partition will be [12]*.

In the example shown in FIG. 3, three states with E_{<3} are identified by a single partition, [2] [3] *. Then, by lumping these identified states together and proceeding with the search, the calculation load can be greatly reduced compared to considering the link states themselves. The search is terminated when the partition becomes a branch-and-cut partition.

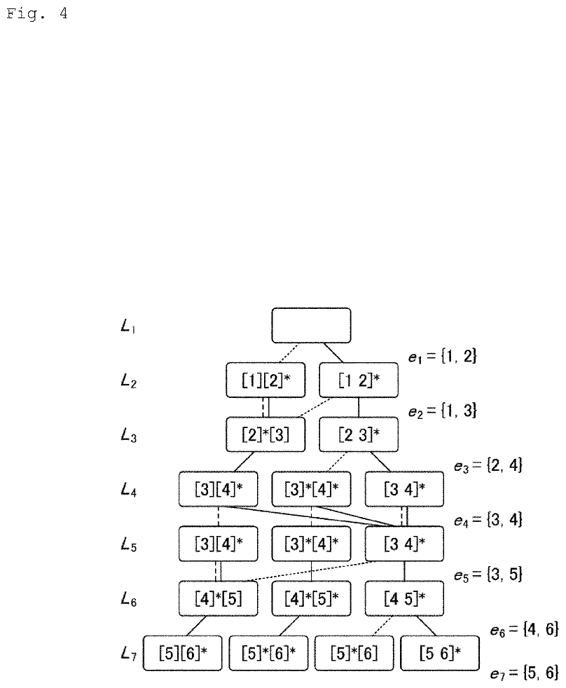

FIG. 4 shows the search diagram when the search shown in FIG. 3 is advanced and all the searches are completed. As shown in FIG. 4, the search diagram is layered, and the partitions corresponding to the states E_{<i} are lined up as vertices in Lᵢ of the i−th layer. From each vertex (partition) P of Lᵢ of the i−th layer, two edges extend to the vertex of Lᵢ₊₁ of the i+1-th layer, and these two edges correspond to eᵢ being working and eᵢ having failed. In the example shown in FIG. 4, the edge corresponding to eᵢ being working is represented by a solid line and the edge corresponding to eᵢ having failed is represented by a dashed line. In the following, for the partition P, P^{HI} denotes the next partition when eᵢ is working and P^{LO} denotes the next partition when eᵢ fails. In the example shown in FIG. 4, the branch-and-cut partition and the edges leading to the branch-and-cut partition are omitted from the diagram.

When generating the search diagram, the search unit 202 also calculates the correspondence of the blocks for the calculation of the shifting positions of the marks and for later processing by the probability calculation unit 203. b (P;v) denotes the block of the partition P that contains node v∈Fᵢ. For the i-th layer partition P∈Lᵢ and f∈{LO, HI}, if P^{f} is not a branch-and-cut partition, then for each block b∈P, the corresponding block b^{f} is defined as follows.
If b contains node v in Fᵢ₊₁, then b^{f} is b (P^{f}; v), i.e. the node in P^{f} that contains v.
If there is no such node, then b^{Lo}=φ, i.e. there is no block corresponding to P^{LO}. For b^{HI}, it is assumed that, when the link eᵢ connects nodes u and w, if w∈Fᵢ₊₁ and u∈b, then b^{HI}=b (P^{HI}; w). If u∈Fᵢ₊₁ and w∈b, then b^{HI}=b (P^{HI}; u). If neither is true, then b^{HI}=φ.

For example, P^{LO}=P^{HI}=[4]*[5] for P=[3][4] * in 5th layer L₅ in FIG. 4, but for the block with b=[4]*, b^{Lo}=b^{HI}=[4]* because node 4 is also in F₆. On the other hand, for b=[3], b^{LO}=φ because node 3 does not exist in F₆. However, e5 connects node 3 and node 5, and b^{HI}=[5] because node 5 is present in F₆.

### <<Algorithm of Process Executed by Search Unit 202>>

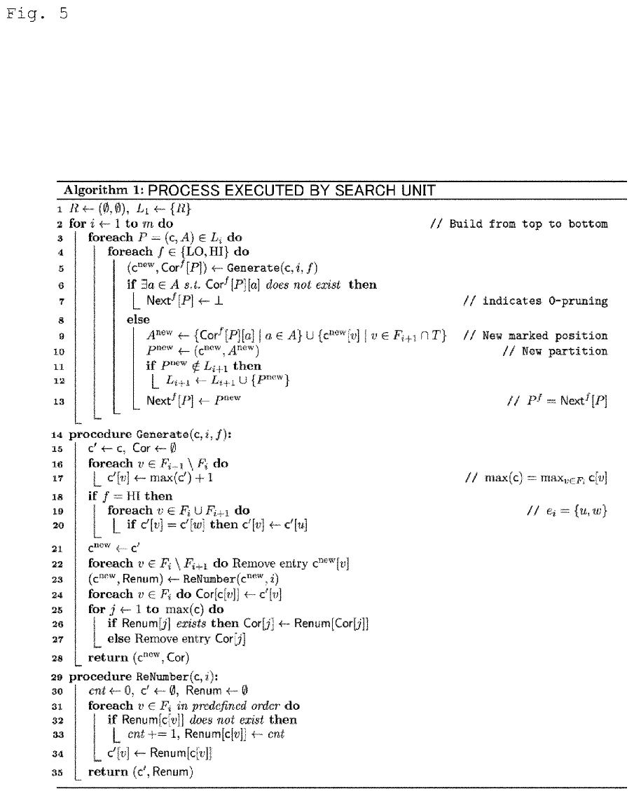

One example of the algorithm of the process by which the search unit 202 generates (constructs) the search diagram as described above is shown in FIG. 5. In this algorithm, each vertex, or partition, of the search diagram is represented by a pair of an associative array c: Fᵢ→Z₊ and a set of integers A⊏Z₊. Z₊ is the entire set of positive integers. The associative array c represents numbered blocks.

Let c be such that c [u]=c [w] for node u, w∈Fᵢ only if u and w belong to the same block. A also represents the position of the marker by the set of numbers of the blocks that are marked. For example, the partition [3][4] * is represented by the pair c={3→1, 4→2} and A={2}. The partition of the i−th layer is stored in the set of vertices Lᵢ.

First, in the 1st row, the top vertex R of the search diagram is created and stored in Lᵢ. Since there is no node belonging to Fᵢ, SO R is represented as a pair of an empty associative array q and an empty set φ. The following rows 2 to 13 correspond to the part where the search diagram is created top-down from top to bottom. The 3rd row represents the iteration that looks at all the partitions P from the vertex set Lᵢ of the i−th layer, and the 4th row represents the iteration that handles both the case where the link eᵢ fails (LO) and the case where it is working (HI). The next 5th row generates an associative array c^{new} of the i+1th layer based on c of the i−th layer, according to the state of link eᵢ, and an associative array Cor^{f} [P], which represents the correspondence between the original c and the block with c^{hew}. Cor^{f} [P] is an associative array such that for a block b with number j in the original c, if the corresponding block b^{f} exists, its number in c^{hew} is stored in Cor^{f} [P][j], and if not, there is no entry Cor^{f} [P][j] corresponding to number j. This associative array Cor^{f} [P] is also used in later probability calculation. The “Generate” operation in the 5th row is described in detail in the 14th row and thereafter.

In 6-13th rows, the next vertex (division) p^{new} of vertex (partition) P is stored in Next^{f} [P]. 6-7th rows determine whether the next partition is a branch-and-cut partition or not, depending on whether the block corresponding to the marked block exists or not. Specifically, if there is a number a in A for which Cor^{f} [P] [a] does not exist, it is a branch-and-cut partition. Otherwise, a new set of numbers of mark locations, A^{new}, is computed as in the 9th row. The pair of c^{new} and A^{new} thus generated is the new partition p^{new}, and if it has not yet been generated as the partition of the 1+1th layer, p^{new} is added to Li+1 (10-12th row). p^{new} is stored in Next^{f} [P] at the 13th row.

14th row and thereafter are the details of the “Generate” operation in the 5th row. 15th row assigns c to c′ and makes Cor an empty associative array. 16-17th rows assign the number max (c′)+1 to the node that is included in Fᵢ₊₁ but not in Fᵢ. 18-20th rows are process of the case where f=HI, i.e. eᵢ is working. In this case, assuming that eᵢ connects node u and node w, all elements of c′ numbered c′[w] are rewritten to c′[u]. In 21-22nd rows, c^{new} is the entry for the node that is included in Fᵢ but not in Fin, removed from c′. 23rd row performs an operation called ReNumber on c^{new}. The “ReNumber” operation is an operation to renumber the associative array c to make it unique for each partition, because even partitions of the same block can result in different associative arrays c depending on the numbering. At this time, the “ReNumber” operation simultaneously generates a mapping Renum from the original number to the new number. The details of this “ReNumber” operation are as described in 29-35th rows. Note that 31st row indicates that the processes of 32-34th rows are performed for v∈Fᵢ in a predetermined order.

The subsequent 24-27th rows are the processes of calculating the associative array Cor that represents the correspondence of the blocks. In the 24th row, the process for each node of Fᵢ generates an entry Cor [c [v]] in Cor. In lines 25-27th rows, the numbers in Cor are renumbered using Renum. 28th row returns the pair of c^{new} and Cor.

### <Details of Process Executed by Probability Calculation Unit 203>

The probability calculation unit 203 calculates the probability of reliability based on the search diagram generated by the search unit 202 and the correspondence between the blocks. It is important to note that the following two values of probability are calculated for each of the partitions P∈Lᵢ for the i−th layer.
p (P): Probability that the partition corresponding to the states of link set E_{<i} up to the i−1st is P.
q (P, b): Probability that block b of P is connected to all source nodes by the state of link set E_{<i} from i−th onward when the partition by the state of link set E_{<i} up to i−1st is P.

While the above p (P) is a probability that is also used in existing methods such as NPL 1, it is unique to the proposed method to consider a probability for each block as in q (P, b). The probability R_{G,p} (T␣{v}) of a target node v connecting to all source nodes can be calculated by the following Equation (4) by focusing on the layers in which v is included in Fᵢ.

[Eq. 4]

$${R}_{G , p} ( T ⋃ \{ v \} ) = {\sum }_{P ∈ {L}_{i}} p ( P ) \cdot q ( P , b ( P ; v ) ) ( v ∈ {F}_{i} ) \qquad ( 4 )$$

Note that if the connected undirected graph G input by the input unit 201 consists only of nodes of degree 2 or higher, then there is always a Fᵢ containing v.

p (P) can be calculated by the following Equation (5).

[Eq. 5]

$$p ( P ) = ( 1 - {p}_{i} ) \cdot {\sum }_{Q ∈ {L}_{i} : {Q}^{LO} = P} p ( Q ) + {p}_{i} \cdot {\sum }_{Q ∈ {L}_{i} : {Q}^{HI} = P} p ( Q ) ( P ∈ {L}_{i + 1} ) \qquad ( 5 )$$

By setting the value of p for the top layer partition as 1 and applying the above Equation (5) top-down from the top to the bottom of the search diagram, the value of p (P) can be calculated for all partitions. The value of p for the branch-and-cut partition is assumed to be 0.

The value of q (P, b) can then be calculated by the following Equation (6) using the block correspondence if P^{LO} and P^{HI} are not branch-and-cut partitions.

[Eq. 6]

$$q ( P , b ) = ( 1 - {p}_{i} ) \cdot q ( {P}^{LO} , {b}^{LO} ) + {p}_{i} \cdot q ( {P}^{HI} , {b}^{HI} ) \qquad ( 6 )$$

If there is no block b^{f} corresponding to b, then q (·, φ)=0. By applying the above Equation (6) bottom-up from the bottom of the search diagram to the top, the value of q (P, b) can be calculated for all partitions and blocks. If P^{f} is a branch-and-cut partition, q (p^{f}, b^{f}) in Equation (6) is replaced with 1 only if the source nodes all appear in E_{<i} and b is the only marked block in P, otherwise it is replaced with 0. Furthermore, if P^{HI} is a branch-and-cut partition and none of the endpoint nodes u and w of link eᵢ are in Fᵢ₊₁, the next exception is made. That is, if the source nodes all appear in E_{<i} and b (P; u)≠b (P;w), i.e. the block containing u and the block containing w are different, when b (P;u) is the only marked block, q (P, b (P;u))=1, q (P, b (P; w))=pᵢ, and when b (P; w) is the only marked block, q (P,b (P;w))=1, q (P,b (P;u))=pᵢ. If b (P;u) and b (P;w) are the only two marked blocks, then q (P,b (P;u))=q (P,b (P;w))=pᵢ.

### <<Algorithm of Process Executed by Probability Calculation Unit 203>>

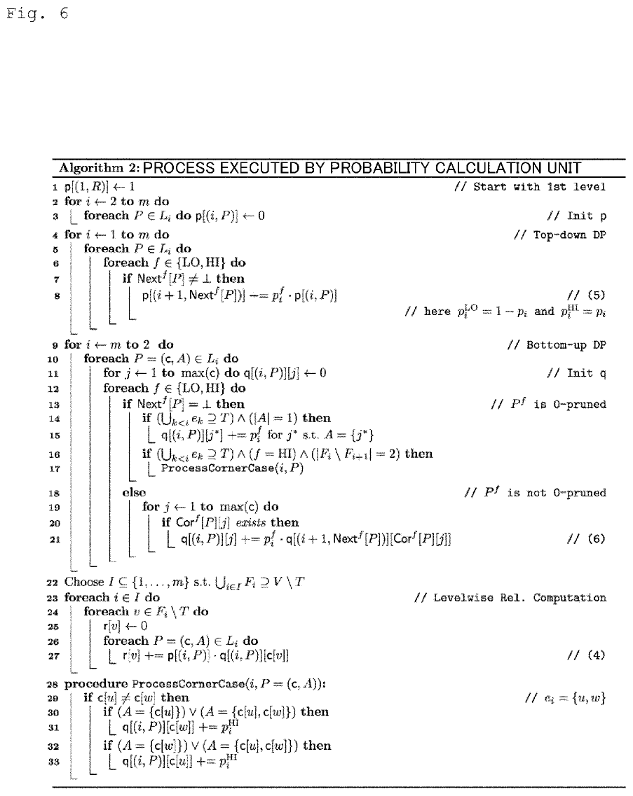

One example of the algorithm for the process by which the probability is calculated by the probability calculation unit 203 as described above is shown in FIG. 6. In this algorithm, p (P) corresponding to the partition P of the i−th layer is represented by p[(i, P)] and q (P,b) is represented by q[(i, P)][j] (where j is the number in c of that block), respectively. The value of the probability R_{G,p} (T␣{v}) to be finally obtained is stored in r [v].

1-8th rows correspond to the part where the value of p (P) is obtained by dynamic programming following a top-down approach. In 1-3rd rows, p[(1, R)] is initialized to 1 for the top node R, and all other values of p are initialized to 0. Thereafter, starting from the top layer (4th row), for each partition P in the i−th layer (5th row), the value of p in each partition is calculated using the above Equation (5) (6-8th rows). Note that pᵢ^{LO}=1-pᵢ and pᵢ^{HI}=pᵢ.

9-21st rows correspond to the part where the value of q (P, b) is obtained by dynamic programming following a bottom-up approach. Starting from the bottom layer (9th row), for each partition P in the i−th layer (10th line), first initialize all q (P;·) values to 0 (11th row).

13-17th rows represent the process for the case where the next partition is a branch-and-cut partition. 14-15th rows represent the process for “when all source nodes appear in E_{<i} and b is the only marked block in P”. 16-17th rows represent “exception handling”. Note that the exception handling is detailed in 28-33rd rows as a “ProcessCornerCase” operation.

18-21st rows, on the other hand, are the process corresponding to the case where the next partition is not a branch-and-cut partition. In this case, the above Equation (6) is used to calculate the value of q for each. Note that the condition in the 20th row represents the condition that for a block with number j in partition P, there exists a block corresponding to it.

The last 22-27th rows correspond to the part where the reliability values for each target node are calculated. In the 22nd row, a set I of index i of Fᵢ is selected such that all target nodes are covered. Thereafter, for each i∈I, for the i−th layer, the above Equation (4) is used to find the probability that each target node is connected to all the source nodes. This gives a probability R_{G,p} (T␣{v}) of reliability for each target node V∈V\T.

### Summary of Embodiments

As described above, the reliability calculation device 10 in the present embodiment can solve k-NR+, which requires reliability to be calculated or all target nodes, with the same calculation load as solving k-NR using the convention method. For example, a graph with 100 nodes can be expected to be approximately 100 times faster than a graph with 100 nodes, because the conventional method required solving k-NR+ for the number of target nodes to solve k-NR+. This makes it possible, for example, to obtain all the probabilities that each client connects to all the servers in a single calculation in a client-server model. Further, in terms of solving a stand-alone K-NR, the reliability calculation device 10 according to the present embodiment can solve it faster than conventional methods when k is small.

The reliability calculation device 10 according to the present embodiment may, for example, perform various network controls using the obtained reliability values. For example, with respect to a target node with a low reliability value, the control may be performed by increasing the number of routes from the server by operating a link in the standby system, or may take measures to reduce the failure probability of a link in the route.

### REFERENCES

Reference 1: Yuma Inoue and Shin-Chi Minato. Acceleration of ZDD construction for subgraph enumeration via pathwidth optimization. Technical Report of Division of Computer Science, Hokkaido University, TCS-TR-A-16-80, 2016.

The present invention is not limited to the specifically disclosed embodiments, and various modifications, changes, combinations with known techniques, and the like can be made without departing from the scope of the claims.

### REFERENCE SIGNS LIST

10: Reliability calculation device
101: Input device
102: Display device
103: External interface
103a: Recording medium
104: Communication interface
105: Processor
106: Memory device
107: Bus
201: Input unit
202: Search unit
203: Probability calculation unit
204: Output unit

1. A reliability calculation method executed by a computer, the method comprising:
inputting a connected undirected graph G=(V,E), an operation probability pᵢ of a link eᵢ∈E that constitutes the undirected graph G, and a predetermined set T⊏V of k-1 source nodes;
generating a directed acyclic graph for calculating a reliability R_{G,p} (T␣{v}) representing the probability that each target node v∈V\T is connected to each of the k-1 source nodes, based on the undirected graph G, the operation probability of operation pᵢ, and the set T; and
calculating the reliability R_{G,p} (T␣{v}) for each target node v based on the directed acyclic graph and a correspondence between each vertex of the directed acyclic graph and its adjacent vertex.

2. The reliability calculation method according to claim 1, wherein the generating of the directed acyclic graph includes:
determining the order of E={e₁, . . . , eₘ}, where m=|E|;
calculating a partition for state Xxi, which indicates whether each link in a link set E_{<i} is operating or not, based on a set Fᵢ of nodes that are common to nodes constituting each link in the link set E_{<i}={e₁, . . . eᵢ₋₁} up to the i−th link set and each link in a link set E_{<i}={e₁, . . . , eₘ} from the i−th onwards; and
generating the directed acyclic graph where the partition for state X_{<i} is a vertex of an i−th layer (i=1, . . . , m) and the same partition is the same vertex.

3. The reliability calculation method according to claim 2, wherein the partition is represented by a pair of blocks separating the nodes in the set Fᵢ and a predetermined mark assigned to the blocks.

4. The reliability calculation method according to claim 3, wherein the calculating of the reliability R_{G,p} (T␣{v}) includes calculating the reliability R_{G,p} (T␣{v}) based on:
a probability p (P) that the partition for the state X_{<i} is P∈Lᵢ, wherein Lᵢ denotes a set of vertices included in the i−th layer of the directed acyclic graph; and
a probability q (P,b) that a block b in P is connected to all source nodes by state X_{<i} of a link set E_{≥i} when partition for the state X_{<i} is P∈Lᵢ.

5. The reliability calculation method according to claim 4, wherein the calculating of the reliability R_{G,p}(T␣{V}) includes calculating:
the probability p (P) by dynamic programming with top-down approach for each vertex of the directed acyclic graph; and
the probability q (P, b) by dynamic programming with bottom-up approach for each vertex of the directed acyclic graph.

6. The reliability calculation method according to claim 1, wherein the generating of the directed acyclic graph includes generating the directed acyclic graph and calculating the correspondence while generating the directed acyclic graph.

7. A reliability calculation device, comprising:
a processor; and
a memory storing program instructions that cause the processor to:
input a connected undirected graph G=(V,E), an operation probability pᵢ of a link eᵢ∈E that constitutes the undirected graph G, and a predetermined set T⊏V of k-1 source nodes;
generate a directed acyclic graph for calculating a reliability R_{G,p} (T␣{v}) representing the probability that each target node v∈V\T is connected to each of the k-1 source nodes, based on the undirected graph G, the operation probability of operation pᵢ, and the set T; and
calculate the reliability R_{G,p} (T␣{v}) for each target node v based on the directed acyclic graph and a correspondence between each vertex of the directed acyclic graph and its adjacent vertex.

8. A non-transitory computer-readable recording medium having stored therein a program for causing a computer to execute the reliability calculation method according to claim 1.
